(19) United States
(12) Patent Application Publication
(10) Pub. No.: US 2026/0341848 A1
(43) Pub. Date: Oct. 29, 2026

(54) FUEL CELL SYSTEM

(71) Applicant: AISAN KOGYO KABUSHIKI KAISHA, Obu-shi, Aichi (JP)

(72) Inventor: Daisaku ASANUMA, Gamagori-shi (JP)

(73) Assignee: AISAN KOGYO KABUSHIKI KAISHA, Obu-shi, Aichi (JP)

(21) Appl. No.: 19/483,804

(22) PCT Filed: Mar. 7, 2024
(86) PCT No.: PCT/JP2024/008678

§ 371 Date: Nov. 12, 2025

(30) Foreign Application Priority Data
Jun. 6, 2023 (JP) 2023-093194

(51) Int. Cl. H01M 16/00; B60L 50/75; B60L 58/40; H01M 8/04858; H01M 10/44; H01M 10/46

(52) U.S. Cl. CPC H01M 16/006; H01M 8/04895; H01M 10/44; H01M 10/46; B60L 50/75; B60L 58/40; B60L 2200/30; H01M 2220/20; H01M 2250/20

(57) ABSTRACT

This fuel cell system includes: an FC; a motor; a first power line that connects the FC and the motor; a battery; a second power line that connects the battery and the first power line; a variable resistor that is provided to the first power line and is configured so as to be able to change the resistance value; and an ECU that controls the resistance value of the variable resistor so that the current value of the FC is in an allowable current use range.

### CROSS-REFERENCE TO RELATED APPLICATIONS

This is a US national phase application based on the PCT International Patent Application No. PCT/JP2024/008678 filed on Mar. 7, 2024, and claiming the priority to Japanese Patent Application No. 2023-093194 filed on Jun. 6, 2023, the entire contents of which are incorporated by reference herein.

### TECHNICAL FIELD

The technique disclosed in this description relates to a fuel cell system, which will be used as a power source for electric vehicles and includes a fuel cell connected to a load device, and a battery placed in a discharge path extending from the fuel cell to the load device and connected in parallel to the fuel cell.

### BACKGROUND ART

As the above type of technique, for example, a fuel cell system described in the following Patent Document 1 is conventionally known. This system includes a fuel cell, a load device, a first power wire connecting the fuel cell and the load device, a battery, and a second power wire connecting the battery and the first power wire. On the first power wire, a voltage converter is provided to convert voltage between an inter-terminal voltage of the fuel cell and a voltage on a load device side.

### RELATED ART DOCUMENTS

### Patent Documents

Patent Document 1: Japanese unexamined patent application publication No. 2011-228294.

### SUMMARY OF INVENTION

### Problems to be Solved by the Invention

In the fuel cell system described in Patent Document 1, the voltage converter can control the supply of electric power to the load device so that the electric power does not exceed an upper-limit power of the fuel cell. However, this voltage converter itself may lead to increased cost and size. In recent years, fuel cell systems to be mounted in electric vehicles, etc. have been demanded to be configured as simple and low-cost systems.

The disclosure has been made to address the above problems and has a purpose to provide a fuel cell system, which is simple and low-cost, and can control electric power to be supplied to a load device so that the electric power does not exceed upper-limit power of a fuel cell and a battery without using a voltage converter.

### Means of Solving the Problems

(1) To achieve the above purpose, one aspect of the disclosure provides a fuel cell system including: a fuel cell; a load device; a first power line connecting the fuel cell and the load device; a battery; and a second power line connecting the battery and the first power line, wherein the fuel cell system further includes: variable resistance means provided on the first power line or the second power line and configured so that a resistance value can be changed; and control means for regulating the resistance value of the variable resistance means so that a current value of the fuel cell falls in a current usage range which is allowable.
According to the above-described configuration (1), the control means controls the electric power to be supplied from the fuel cell and the battery to the load device by controlling the variable resistance means so that the current value of the fuel cell falls within the allowable current usage range. Thus, the charge rate of the battery can be adjusted closer to a median value and the fuel cell is used in the allowable current usage range.
(2) To achieve the above purpose, in the above-described configuration (1), preferably, the variable resistance means is a variable resistor configured so that a resistance value can be changed.

According to the above-described configuration (2), the variable resistance means is the variable resistor, so that the operations equivalent to the configuration (1) can be achieved.
(3) To achieve the above purpose, in the above-described configuration (1), preferably, the variable resistance means is a resistance device including at least one resistor-relay circuit provided with one resistor and one relay connected in parallel to the resistor, the resistance device being configured so that a resistance value can be changed in multiple stages by opening and closing the one relay of the at least one resistor-relay circuit.

According to the above-described configuration (3), the variable resistance means is the resistance device, so that the operations equivalent to the configuration (1) can be achieved.
(4) To achieve the above purpose, the above-described configuration (2) preferably further includes monitoring means for monitoring a charge rate of the battery, wherein when the charge rate under monitoring is a predetermined first charge rate or less, the control means controls the variable resistance means to regulate the resistance value to a predetermined first resistance value, and when the charge rate under monitoring is a predetermined second charge rate or more, the control means controls the variable resistance means to regulate the resistance value to a predetermined second resistance value that is higher than the first resistance value.

According to the above-described configuration (4), in addition to the operations of the configuration (2), the control means controls the variable resistor according to the charge rate of the battery under monitoring, thereby adjusting the charge rate closer to almost a median value, and the fuel cell is intermittently controlled to an idle state.
(5) To achieve the above purpose, the above-described configuration (3) preferably further includes monitoring means for monitoring a charge rate of the battery, wherein when the charge rate under monitoring is a predetermined first charge rate or less, the control means controls the one relay of the at least one resistor-relay circuit to open to regulate the resistance value to a predetermined first resistance value, and when the charge rate under monitoring is a predetermined second charge rate or more, the control means controls at least one more relay (22) than when the charge rate is the first charge rate or less to open to regulate the resistance value to a predetermined second resistance value that is higher than the first resistance value.

According to the above-described configuration (5), in addition to the operations of the configuration (3), the control means controls the resistance device according to the charge rate of the battery under monitoring, thereby adjusting the charge rate closer to a substantial median value, and the voltage of the fuel cell is intermittently controlled to an idle state.
(6) To achieve the above purpose, the above-described configuration (2) preferably further includes measuring means for measuring a current value of the fuel cell, wherein when the current value under measuring is a high-current side value in the current usage range of the fuel cell, the control means controls the variable resistor to reduce the resistance value of the variable resistor so that a voltage value of the battery is above a lower limit of a voltage usage range which is allowable, and when the current value under measuring is a low-current side value in the current usage range of the fuel cell, the control means controls the variable resistor to increase the resistance value of the variable resistor so that the voltage value of the battery is below an upper limit of the voltage usage range or the fuel cell avoids being subjected to high voltage.

According to the above-described configuration (6), in addition to the operations of the configuration (2), the control means controls the variable resistor according to the current value of the fuel cell under measuring, so that the current value of the fuel cell is close to the current usage range.
(7) To achieve the above purpose, the above-described configuration (3) preferably further includes measuring means for measuring a current value of the fuel cell, wherein when the current value under measuring is a high-current side value in the current usage range of the fuel cell, the control means controls at least one of the relay to close to reduce the resistance value of the resistance device, and when the current value under measuring is a low-current side value in the current usage range of the fuel cell, the control means controls the one relay of the at least one resistor-relay circuit to open to increase the resistance value of the resistance device.

According to the above-described configuration (7), in addition to the operations of the configuration (3), the control means controls at least one relay of the resistance device according to the current value of the measured fuel cell, so that the current value of the fuel cell is close to the current usage range.
(8) To achieve the above purpose, the above-described configuration (2) preferably further includes measuring means for measuring a voltage value of the fuel cell, wherein, based on the voltage value measured for a predetermined time during startup or stop of the fuel cell, the control means regulates a resistance value of the variable resistor so that the voltage value of the battery is a maximum voltage value or less or the fuel cell avoids being subjected to high voltage.

According to the above-described configuration (8), in addition to the operations of the configuration (2), during startup or stop of the fuel cell, the control means controls the variable resistor according to the measured voltage value of the fuel cell, thereby suppressing the voltage of the battery from exceeding the upper-limit value.
(9) To achieve the above purpose, the above-described configuration (3) preferably further includes measuring means for measuring a voltage value of the fuel cell, wherein, when the voltage value measured for a predetermined time during startup or stop of the fuel cell exceeds a maximum voltage value of the battery or when the fuel cell avoids being subjected to high voltage, the control means controls the one relay of the at least one resistor-relay circuit to increase the resistance value.

According to the above-described configuration (9), in addition to the operations of the configuration (3), during startup or stop of the fuel cell, the control means controls at least one relay according to the measured voltage value of the fuel cell, thereby suppressing the voltage of the battery from exceeding the upper-limit value.

### Effects of the Invention

The above-described configuration (1) can provide a simple and low-cost fuel cell system capable of controlling electric power to be supplied to the load device so that the electric power does not exceed the upper-limit power of the fuel cell and the battery, without using a voltage converter.

The above-described configuration (2) can achieve the effects equivalent to the configuration (1).

The above-described configuration (3) can achieve the effects equivalent to the configuration (1).

In addition to the effects of the configuration (2), the above-described configuration (4) can control the electric power supplied to the load device so that the electric power does not exceed the upper-limit power of the fuel cell and the battery by controlling the resistance value of the variable resistor according to the charge rate of the battery. This can also suppress high-voltage application to the fuel cell.

In addition to the effects of the configuration (3), the above-described configuration (5) can control the electric power supplied to the load device so that the electric power does not exceed the upper-limit power of the fuel cell and the battery by controlling the resistance value of the resistance device according to the charge rate of the battery. This can also suppress the fuel cell from being subjected to high voltage.

In addition to the effects of the configuration (2), the above-described configuration (6) can control the electric power supplied to the load device so that the electric power does not exceed the upper-limit power of the fuel cell and the battery by controlling the resistance value of the variable resistor according to the current value of the fuel cell. This can also suppress high-voltage application to the fuel cell.

In addition to the effects of the configuration (3), the above-described configuration (7) can control the electric power supplied to the load device so that the electric power does not exceed the upper-limit power of the fuel cell and the battery by controlling the resistance value of the resistance device according to the current value of the fuel cell. This can also suppress high-voltage application to the fuel cell.

In addition to the effects of the configuration (2), the above-described configuration (8) can control the electric power supplied to the load device so that the electric power does not exceed the upper-limit power of the fuel cell and the battery by controlling the resistance value of the variable resistor according to the voltage value of the fuel cell. This can also suppress high-voltage application to the fuel cell.

In addition to the effects of the configuration (3), the above-described configuration (9) can control the electric power supplied to the load device so that the electric power does not exceed the upper-limit power of the fuel cell and the battery by controlling the resistance value of the resistance device according to the voltage value of the fuel cell. This can also suppress high-voltage application to the fuel cell.

### BRIEF DESCRIPTION OF THE DRAWINGS

FIG. 1 is a block diagram showing a fuel cell system mounted in an electric cart in a first embodiment.

FIG. 2 is a flowchart showing contents of an electric power supply control in the first embodiment.

FIG. 3 is a required resistance value map to be referenced to determine a required resistance value according to a charge rate of a battery in the first embodiment.

FIG. 4 is a time chart showing changes in (A) vehicle speed of electric cart and (B) charge rate of battery in the first embodiment.

FIG. 5 is a time chart showing changes in (A) vehicle speed of electric cart, (B) charge rate of battery, and (C) resistance value of a variable resistor in the first embodiment.

FIG. 6 is a flowchart showing contents of an electric power supply control in a second embodiment.

FIG. 7 is a time chart briefly showing changes in (A) charge rate and (B) FC voltage value.

FIG. 8 is a time chart showing changes in (A) resistance value of a variable resistor and (B) charge rate of battery in the second embodiment.

FIG. 9 is a circuit diagram showing a resistance device in a modified example of the second embodiment.

FIG. 10 is a flowchart showing contents of an electric power supply control in a third embodiment.

FIG. 11 is a graph showing (A) current-voltage characteristics of FC and (B) current-voltage characteristics of battery in the third embodiment.

FIG. 12 is a time chart showing changes in (A) FC current value, (B) FC voltage value, and (C) required resistance value in the third embodiment.

FIG. 13 is a flowchart showing contents of an electric power supply control in a fourth embodiment.

FIG. 14 is a required resistance value map to be referred to determine a required resistance value according to an FC voltage value in the fourth embodiment.

FIG. 15 is a graph, similar to FIG. 11, showing (A) current-voltage characteristics of FC and (B) current-voltage characteristics of battery in the fourth embodiment.

FIG. 16 is a time chart showing changes in (A) FC current value and (B) FC voltage value when a variable resistor is 0Ω during startup of FC in the fourth embodiment.

FIG. 17 is a time chart showing changes in (A) FC current value and (B) FC voltage value when the variable resistor is 1.0Ω during startup of FC in the fourth embodiment.

FIG. 18 is a flowchart showing contents of an electric power supply control in a fifth embodiment.

### MODE FOR CARRYING OUT THE INVENTION

A detailed description of several embodiments of a fuel cell system, applied to compact electric vehicles (electric carts), will now be given referring to the accompanying drawings.

### First Embodiment

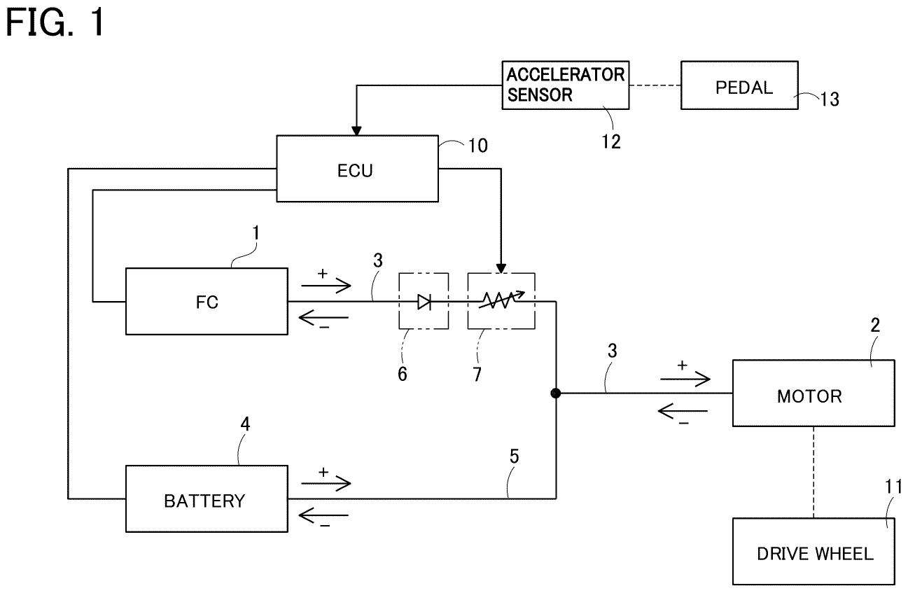

The details of a first embodiment will be described first with reference to FIG. 1 to FIG. 5.

### [Overview of Fuel Cell System]

FIG. 1 is a block diagram showing a fuel cell system mounted in an electric cart in the present embodiment. This fuel cell system includes a fuel cell (FC) 1, an electrically-operated motor 2, a first power line 3 connecting the FC 1 and the motor 2, a battery 4, and a second power line 5 connecting the battery 4 and the first power line 3. The second power line 5 is connected to the first power line 3 provided between a variable resistor 7 and the motor 2.

The FC 1 is an electrochemical cell that converts the chemical energy of fuel and oxidant into electricity through an oxidation-reduction reaction, and has a well-known configuration. The motor 2 has a well-known configuration and corresponds to one example of a “load device” of the disclosure. The battery 4 in the present embodiment consists of a secondary battery that can be charged and discharged.

In the present embodiment, on the first power line 3, a diode 6 for rectification and the variable resistor 7 configured so that its resistance value can be adjusted are provided. The variable resistor 7 has a well-known configuration that is electrically operated to change its resistance value steplessly, and corresponds to one example of “variable resistance means” of the disclosure. The fuel cell system further includes an electronic control unit (ECU) 10 for controlling the resistance value of the variable resistor 7. The ECU 10 has a well-known configuration including a central processing unit (CPU) for performing arithmetic processing, a memory, input/output ports, etc. The ECU 10 corresponds to one example of “control means” of the disclosure.

In the present embodiment, the motor 2 is drive-coupled to a drive wheel 11 of an electric cart. An accelerator sensor 12 is connected to the ECU 10. The accelerator sensor 12 is configured to detect an operation angle of a pedal 13 operated by a user of the electric cart as an accelerator opening degree, and output a detection signal thereof to the ECU 10.

The ECU 10 is electrically connected to the battery 4 and configured to monitor a charge rate SOC of the battery 4. The ECU 10 also corresponds to one example of “monitoring means” of the disclosure. Further, the ECU 10 is electrically connected to the FC 1 and configured to measure a current value of the FC 1. The ECU 10 also corresponds to one example of “measuring means” of the disclosure.

Here, the current value of the FC 1 should not be too low or too high in consideration of the durability of the FC 1, and the FC 1 has to be used within an allowable current usage range. In the present embodiment, therefore, the ECU 10 is configured to execute the following “electric power supply control” during operation of the electric cart so that the current value of the FC 1 falls within the allowable current usage range.

### [Electric Power Supply Control]

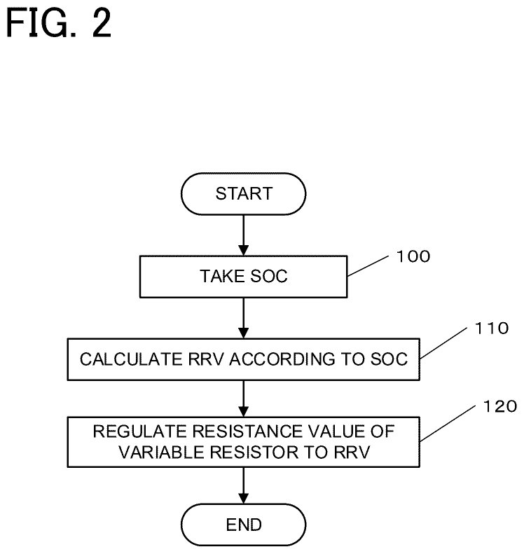

FIG. 2 is a flowchart showing one example of contents of the electric power supply control in the present embodiment, which is stored in the memory of the ECU 10.

When the process enters this routine, in step 100, the ECU 10 takes the charge rate SOC of the battery 4, which is under monitoring.

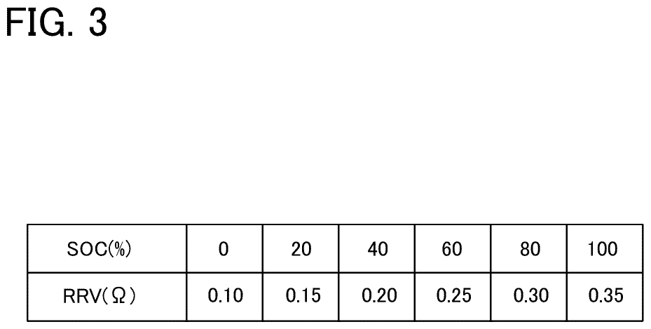

In step 110, the ECU 10 then calculates a required resistance value RRV according to the acquired charge rate SOC. The ECU 10 determines the required resistance value RRV according to the charge rate SOC by, for example, referring to a required resistance value map shown in FIG. 3. This required resistance value map sets required resistance values RRV to bring the charge rate SOC of the battery 4 closer to a median value (50%). Specifically, the required resistance values RRV are set to be higher in a range of “0.10 to 0.35 (Ω)” as the charge rate SOC is higher in a range of “0 to 100 (%)”.

In step 120, the ECU 10 controls the variable resistor 7 to regulate the resistance value of the variable resistor 7 to the required resistance value RRV.

According to the above-described electric power supply control, the ECU 10 is configured to regulate the resistance value of the variable resistor 7 so that the current value of the FC 1 falls within the allowable current usage range. Specifically, the ECU 10 is configured to control the variable resistor 7 to regulate the resistance value of the variable resistor 7 to the required resistance value RRV according to the charge rate SOC so that the charge rate SOC of the battery 4 approaches the median value (50%).

### [Operations and Effects of Fuel Cell System]

According to the fuel cell system configured as above in the present embodiment, the ECU 10 controls the electric power supplied from the FC 1 and the battery 4 to the motor 2 by controlling the variable resistor 7 so that the current value of the FC 1 falls within the allowable current usage range. Thus, the charge rate SOC of the battery 4 is adjusted closer to the median value (50%) without using a voltage transformer, and the FC 1 is operated in the allowable current usage range. In this embodiment, to bring the charge rate SOC of the battery 4 closer to the median value (50%), the charge rate SOC of the battery 4 is monitored, the required resistance value RRV based on the charge rate SOC is determined, and the resistance value of the variable resistor 7 is regulated to the required resistance value RRV. This configuration can consequently adjust the charge rate SOC of the battery 4 closer to the median value (50%) by simply regulating the resistance value of the variable resistor 7, while allowing the FC 1 to output power in an uncontrolled condition, regardless of the operating state of the electric cart. It is further possible to control the output power of the battery 4 so as not to exceed its upper limit. Therefore, this configuration can provide a simple and low-cost fuel cell system that can control the electric power to be supplied to the motor 2 so that it does not exceed the upper-limit electric power of the FC 1 and the battery 4 without using a voltage converter.

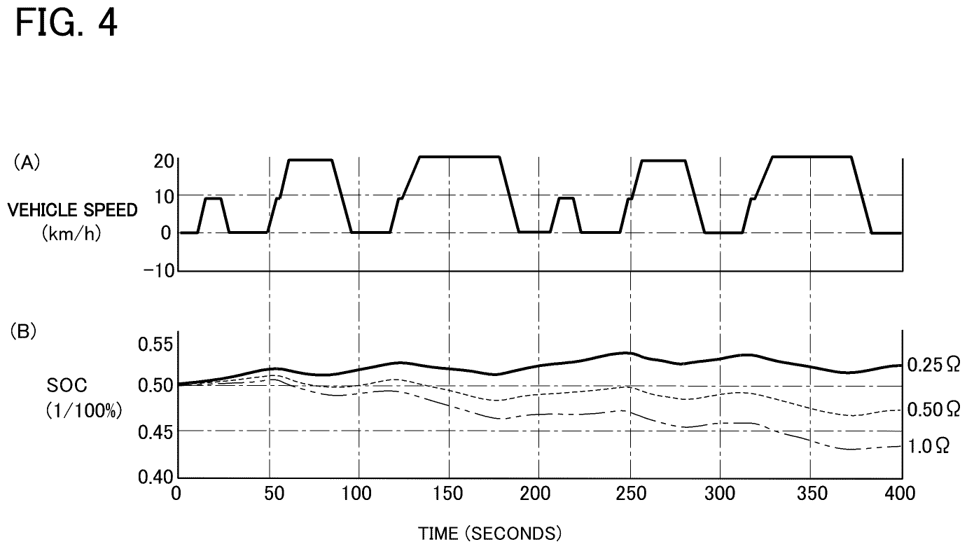

FIG. 4 is a time chart showing changes in (A) vehicle speed of electric cart and (B) charge rate SOC of the battery 4. In (B), a thick line indicates the case where the resistance value of the variable resistor 7 is 0.25Ω, a dashed line indicates the case where the resistance value is 0.50Ω, and a two-dot chain line indicates the case where the resistance value is 1.0Ω.

As shown in FIG. 4 (A), the electric cart is operated to periodically repeat acceleration, deceleration, and stop. At that time, as shown in FIG. 4 (B), when the resistance value is 0.25Ω, the charge rate SOC can be maintained at 50% or higher throughout the entire operation time. However, it is revealed that when the resistance value is 0.50Ω and 1.0Ω, the charge rate SOC falls below 50% at some point after start of the operation.

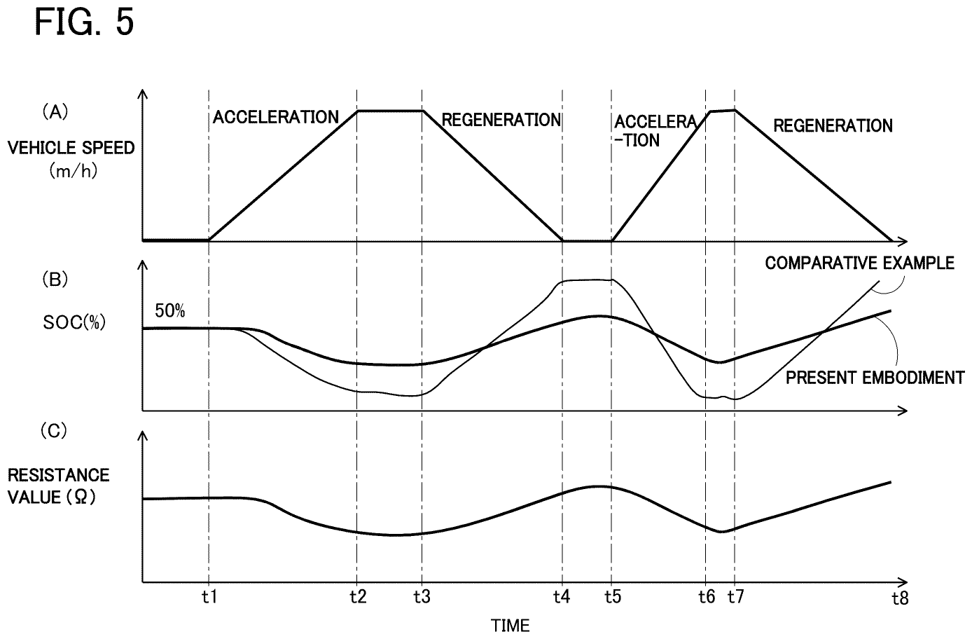

FIG. 5 is a time chart showing changes in (A) vehicle speed of electric cart, (B) charge rate of the battery 4, and (C) resistance value of the variable resistor 7. In (A), the period between times t1 to t2 and the period between times t5 to t6 indicate an acceleration time during which the electric cart is under accelerating and the electric power of the battery 4 is consumed. The period between times t3 to t4 and the period between times t7 to t8 indicate a deceleration time during which regenerated electric power is charged from the motor 2 to the battery 4. In (B), a thick line indicates the present embodiment, and a solid line indicates a comparative example in which the electric power supply control of the embodiment is not executed. In the present embodiment, the resistance value of the variable resistor 7 is controlled according to the charge rate SOC of the battery 4, as can be seen in FIG. 5. Thus, the charge rate SOC of the battery 4 is brought closer to 50% than in the comparative example, regardless of changes in the vehicle speed of the electric cart.

### Second Embodiment

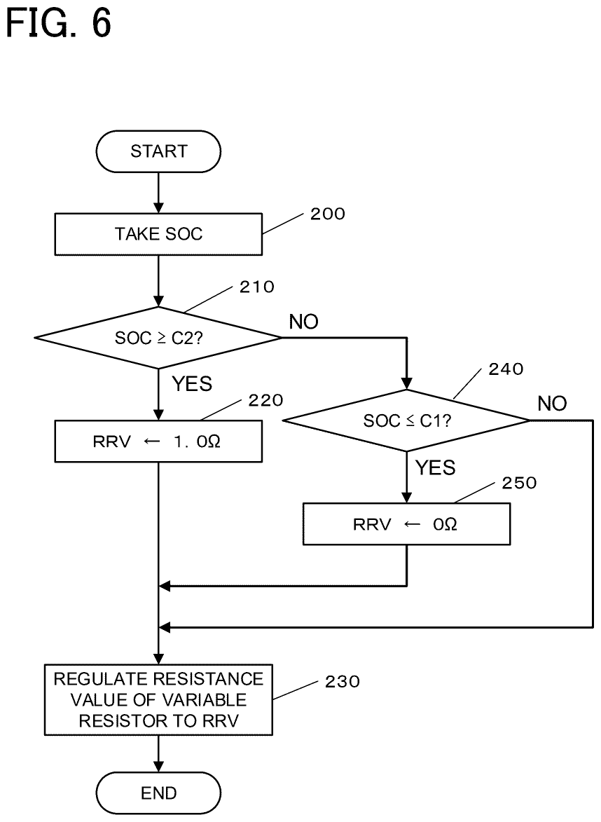

Next, a second embodiment will be described in detail referring to FIG. 6 to FIG. 8. In the following description, similar or identical parts to those in the first embodiment are assigned the same reference signs as in the first embodiment and their details are omitted, and differences from the first embodiment will be mainly described.

### [Electric Power Supply Control]

The present embodiment differs from the first embodiment in the contents of the electric power supply control. In the present embodiment, the following “electric power supply control” is performed to control the charge rate SOC of the battery 4 so that it approaches the median value (50%). FIG. 6 is a flowchart showing the contents of the electric power supply control in the present embodiment.

When the process enters this routine, in step 200, the ECU 10 takes a charge rate SOC of the battery 4 under monitoring.

In step 210, the ECU 10 then determines whether or not the charge rate SOC is a predetermined second charge rate C2 or higher. Here, the second charge rate C2 can be set to “70%”, for example. When this determination result is positive, the ECU 10 advances the process to step 220. When this determination result is negative, the ECU 10 shifts the process to step 240.

In step 220, the ECU 10 sets the required resistance value RRV to “1.0Ω”. This value “1.0Ω” corresponds to one example of a “second resistance value” of the disclosure.

In step 230, the ECU 10 then regulates the resistance value of the variable resistor 7 to the required resistance value RRV, and terminates subsequent processes.

In contrast, in step 240 following step 210, the ECU 10 determines whether or not the charge rate SOC is a first charge rate C1 or lower. Here, the first charge rate C1 can be set to “30%”, for example. When this determination result is positive, the ECU 10 advances the process to step 250. When this determination result is negative, the ECU 10 shifts the process to step 230.

In step 250, the ECU 10 sets the required resistance value RRV to “0Ω”. This value “0Ω” corresponds to one example of a “first resistance value” of the disclosure. Thereafter, the ECU 10 advances the process to step 230.

According to the above-described electric power supply control, to bring the charge rate SOC of the battery 4 closer to the median value (50%), the ECU 10 controls the variable resistor 7 to regulate the resistance value to 0Ω when the monitored charge rate SOC is the first charge rate C1 (30%) or less and controls the variable resistor 7 to regulate the resistance value to 1.0Ω, which is higher than 0Ω, when the monitored charge rate SOC is equal to or higher than the second charge rate C2 that is higher than the first charge rate C1.

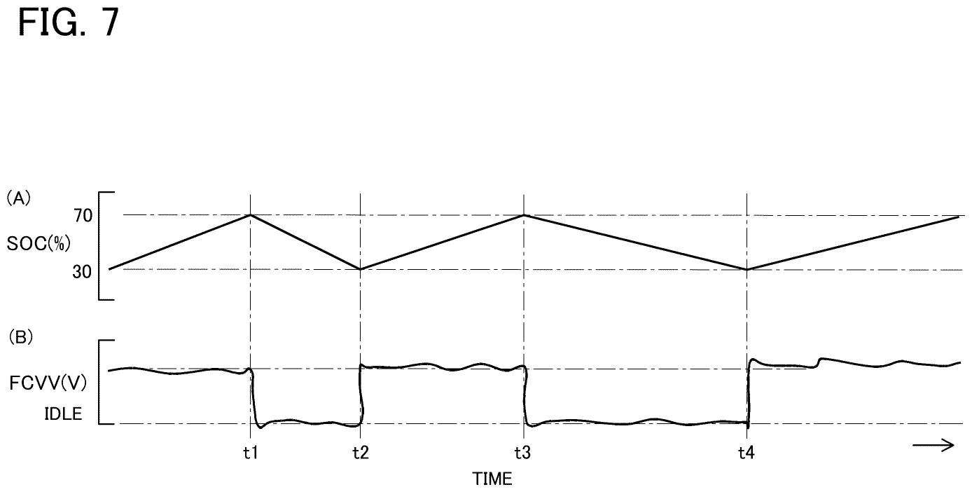

FIG. 7 is a time chart showing changes in (A) charge rate SOC of the battery 4 and (B) FC voltage value FCVV. In the present embodiment, as shown in FIG. 7 (A), the charge rate SOC increases and decreases in the range of “30 to 70 (%)”, and the resistance value of the variable resistor 7 is regulated by the above-described electric power supply control. Thus, the FC voltage value FCVV changes as shown in FIG. 7 (B).

### [Operations and Effects of Fuel Cell System]

According to the fuel cell system configured as above in the present embodiment, the operations and effects equivalent to those in the first embodiment can be achieved. According to the present embodiment, furthermore, the ECU 10 controls the variable resistor 7 according to the monitored charge rate SOC, so that the charge rate SOC approaches almost the median value (50%), and the voltage of the FC 1 is controlled to intermittently enter an idle state. Thus, regulating the resistance value of the variable resistor 7 according to the charge rate SOC of the battery 4 can control the power to be supplied to the motor 2 so as not to exceed the upper limit power of the FC 1 and the battery 4. Further, it is possible to suppress application of high voltage to the FC 1.

According to the configuration in the present embodiment, to bring the charge rate SOC of the battery 4 closer to the median value (50%), the variable resistor 7 is controlled to regulate the resistance value to “1.0Ω” when the charge rate SOC is the second charge rate C2 (70%) or higher, whereas the variable resistor 7 is controlled to regulate the resistance value to “0Ω” when the charge rate SOC is the first charge rate C1 (30%) or lower. Consequently, the charge rate SOC of the battery 4 can be controlled closer to the median value (50%), and regulating the resistance value of the variable resistor 7 to 1.0Ω can place the FC 1 into an idle state. This allows the FC 1 to be placed in the idle state without intermittently stopping the electric cart, and can improve the durability of components of the FC 1 and FC stacks.

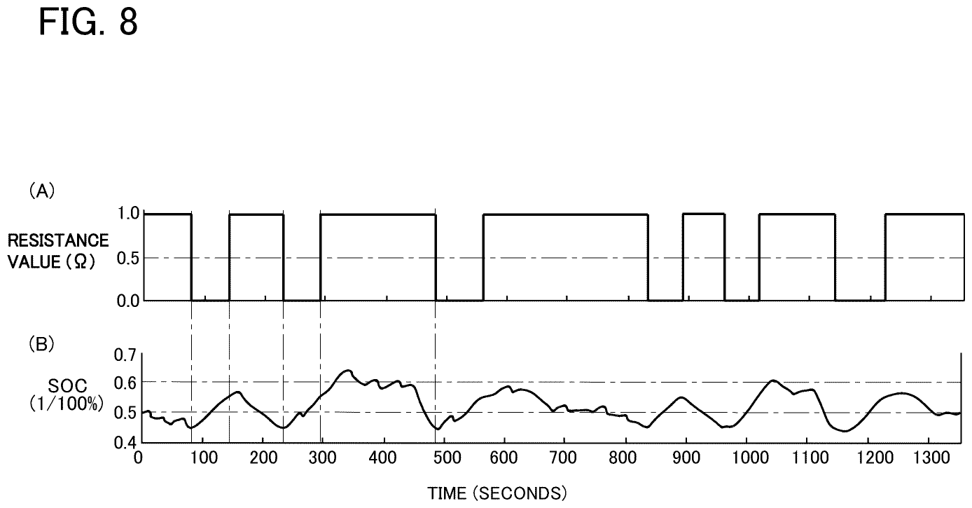

FIG. 8 shows the effects achieved by the above-described electric power supply control. FIG. 8 is a time chart showing changes in (A) resistance value of the variable resistor 7 and (B) charge rate SOC of the battery 4. As is found from FIG. 8, since the resistance value of the variable resistor 7 is controlled in the above-described manner, (A) the resistance value and (B) the charge rate SOC change, and the charge rate SOC approaches the median value (50%) with time, as shown in FIG. 8.

### Modified Example of Second Embodiment

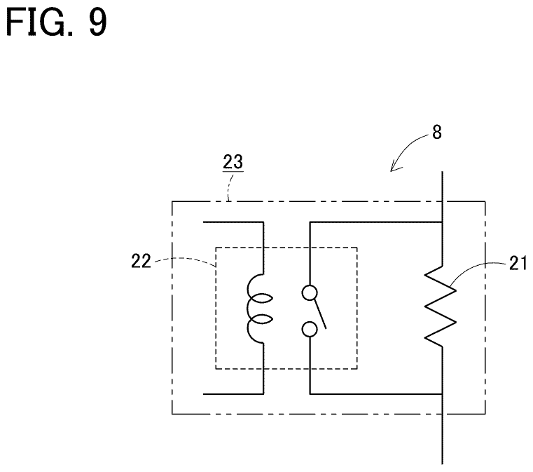

Next, a modified example of the second embodiment will be described referring to FIG. 9. This modified example differs from the second embodiment mainly in configuration of the variable resistance means. In this modified example, on the first power line 3 shown in FIG. 1, a resistance device 8 shown by a circuit diagram in FIG. 9 is provided instead of the variable resistor 7. This resistance device 8 includes one resistor-relay circuit 23 including one resistor 21 and one relay 22 connected in parallel with the resistor 21. This resistance device 8 is configured so that its resistance value can be changed in two stages by opening and closing the one relay 22. In other words, the resistance device 8 is configured to change the resistance value to “1.0Ω” by opening the relay 22 and change the resistance value to “0Ω” by closing the relay 22. This resistance device 8 corresponds to one example of “variable resistance means” of the disclosure.

In the “electric power supply control” in this modified example, the resistance value of the resistance device is regulated to the required resistance value RRV by opening and closing the one relay 22, instead of step 230 of the flowchart shown in FIG. 6.

### [Operations and Effects of Fuel Cell System]

According to the fuel cell system configured as above in the present embodiment, the operations and effects equivalent to those in the second embodiment can be achieved. Specifically, the ECU 10 controls the resistance device 8 to open and close the relay 22 according to the charge rate SOC of the battery 4 under monitoring so that the charge rate SOC approaches almost the median value (50%), and the voltage of the FC 1 is controlled to intermittently enter an idle state. Thus, regulating the resistance value of the resistance device 8 according to the charge rate SOC of the battery 4 can control the power to be supplied to the motor 2 so as not to exceed the upper limit power of the FC 1 and the battery 4. Further, it is possible to suppress application of high voltage to the FC 1.

### Third Embodiment

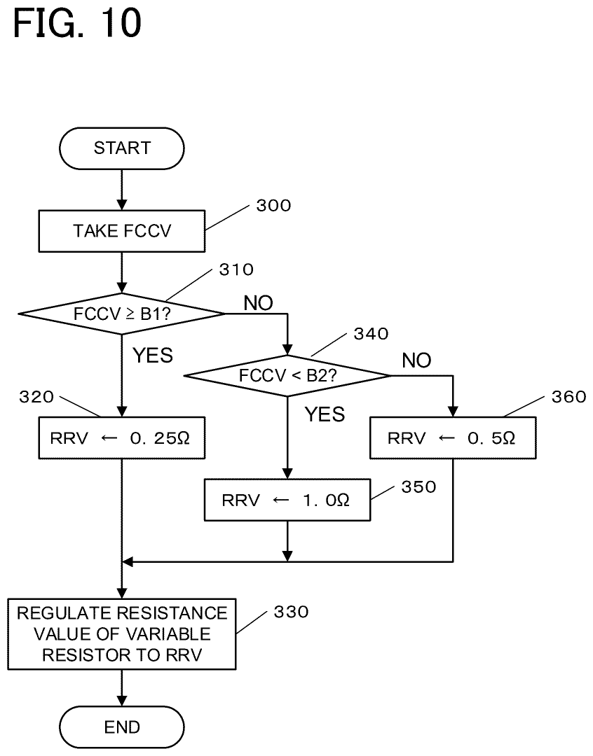

Next, a third embodiment will be described in detail referring to FIG. 10 to FIG. 12.

### [Electric Power Supply Control]

This embodiment differs from each of the above-described embodiments in the contents of the electric power supply control. FIG. 10 is a flowchart showing contents of the “electric power supply control” in the present embodiment.

When the process enters this routine, in step 300, the ECU 10 takes a current value (an FC current value FCCV) of the FC 1 under measurement.

In step 310, the ECU 10 determines whether or not the FC current value FCCV is a first predetermined value B1 or larger in step 310. The first predetermined value B1 means a value on a high current side in the current usage range of the FC 1, and can be set to “40 A”, for example. When this determination result is positive, the ECU 10 advances the process to step 320. When this determination result is negative, the ECU 10 shifts the process to step 340.

In step 320, the ECU 10 sets the required resistance value RRV to “0.25Ω”. This required resistance value RRV means a relatively low resistance value to ensure that the voltage of the battery 4 is above a lower limit of the voltage usage range.

In step 330, the ECU 10 then controls the resistance value of the variable resistor 7 to the required resistance value RRV, and terminates subsequent processes.

In contrast, in step 340, it is determined whether or not the FC current value FCCV is less than a second predetermined value B2. The second predetermined value B2 can be set to “10 A”, for example. When this determination result is positive, the ECU 10 advances the process to step 350. When this determination result is negative, the ECU 10 shifts the process to step 360.

In step 350, the ECU 10 sets the required resistance value RRV to “1.0Ω”. This required resistance value RRV means a relatively high resistance value to ensure that the voltage of the battery 4 is below an upper limit of the voltage usage range. Subsequently, the ECU 10 shifts the process to step 330.

In contrast, in step 360, the ECU 10 sets the required resistance value RRV to “0.5Ω”, then shifts the process to step 330.

According to the above-described electric power supply control, when the measured FC current value FCCV is a value on the high current side in the current usage range of the FC 1, the ECU 10 controls the variable resistor 7 to decrease the resistance value of the variable resistor 7 so that the voltage of the battery 4 is above a lower limit of the voltage usage range. When the measured FC current value FCCV is a value on a low current side in the current usage range of the FC 1, the ECU 10 controls the variable resistor 7 to increase the resistance value of the variable resistor 7 so that the voltage of the battery 4 is below an upper limit of the voltage usage range or the FC 1 avoids being subjected to high voltage.

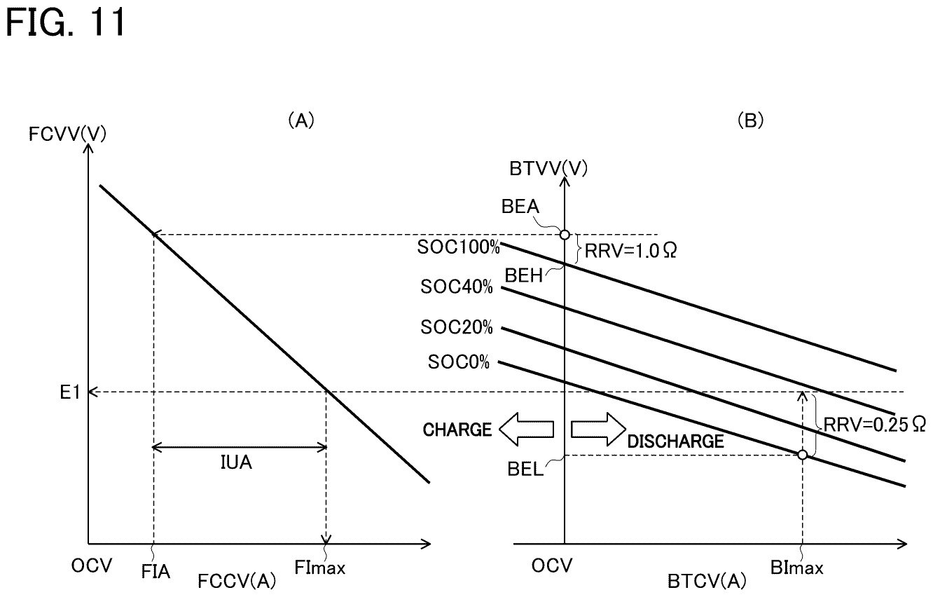

FIG. 11 is a graph showing (A) current-voltage characteristics of the FC 1 and (B) current-voltage characteristics of the battery 4. In the present embodiment, as shown in FIG. 11 (A), for the FC 1, a current usage range IUA is set between a high-voltage avoiding current value FIA (e.g., “5 A”) and a maximum current value FImax (e.g., “50 A”). Further, in the present embodiment, as shown in FIG. 11 (B), the battery 4 has a high-voltage avoiding voltage value BEA set to, for example, “50 V” and is used between a lowest voltage value BEL (e.g., “38 V”) and a highest voltage value BEH (e.g., “42 V”). The highest voltage value BEH is on the line corresponding to a charge rate SOC of 100% and the lowest voltage value BEL is on the line corresponding to a charge rate SOC of 0%.

In the present embodiment, the ECU 10 sets the required resistance value RRV to “0.25Ω” when the FC current value FCCV is high (e.g., “40 A”) to suppress the FC current value FCCV from reaching the maximum current value FImax, and the ECU 10 sets the required resistance value RRV to “1.0Ω” when the FC current value FCCV is low (e.g., “10 A”) to avoid the FC 1 being subjected to high voltage.

### [Operations and Effects of Fuel Cell System]

According to the fuel cell system configured as above in the present embodiment, in addition to the operations and effects in the first embodiment, it is possible to bring the current value of the FC 1 closer to the current usage range by controlling the variable resistor 7 according to the measured current value of the FC 1. Thus, regulating the resistance value of the variable resistor 7 according to the current value of the FC 1 can control the power to be supplied to the motor 2 so as not to exceed the upper limit power of the FC 1 and the battery 4. Further, it is possible to suppress application of high voltage to the FC 1.

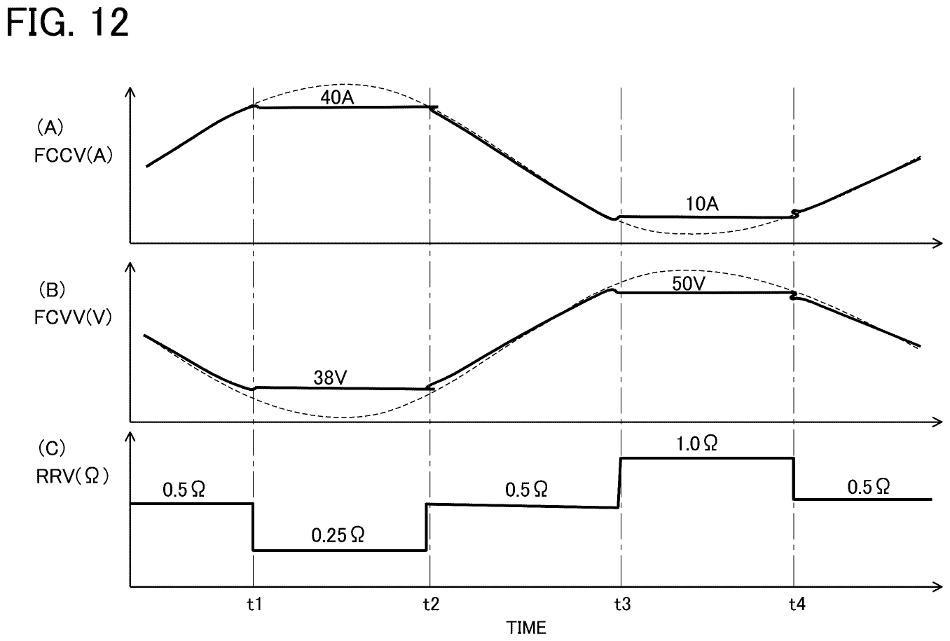

FIG. 12 is a time chart showing changes in (A) FC current value FCCV, (B) FC voltage value FCVV, and (C) required resistance value RRV. In FIG. 12 (A), (B), solid lines indicate the present embodiment and dashed lines indicate a comparative example having no configuration of the present embodiment. In the present embodiment, as shown in FIG. 12, it is revealed that the FC 1 can be used in the current usage range IUA (5 to 50 (A)) by changing the required resistance value RRV to “0.2522,” “0.522,” and “1.022” in response to changes in the FC current value FCCV.

### Modified Example of Third Embodiment

Next, a modified example of the third embodiment will be described. This modified example differs from the third embodiment mainly in configuration of the variable resistance means. In this modified example, on the first power line 3 shown in FIG. 1, a resistance device 8 including three resistor-relay circuits 23 shown in FIG. 9 connected in series is placed instead of the variable resistor 7. This resistance device 8 is configured so that its resistance value can be changed in three stages by selectively opening and closing three relays 22. In other words, the resistance device 8 is configured to change the resistance value to “1.0Ω” by opening all of the relays 22 of the three resistor-relay circuits 23, change the resistance value to “0.5Ω” by opening two relays 22 of the three resistor-relay circuits 23, and change the resistance value to “0.25Ω” by opening one relay 22 of the three resistor-relay circuits 23.

In the “electric power supply control” in the present modified example, the resistance value of the resistance device 8 is regulated to the required resistance value RRV by selectively opening and closing the three relays 22, instead of step 330 shown in FIG. 10.

### [Operations and Effects of Fuel Cell System]

According to the fuel cell system configured as above in this modified example, it is possible to achieve equivalent functions and effects to those of the third embodiment. Specifically, the ECU 10 controls the resistance device 8 according to the measured current value of the FC 1, thereby adjusting the current value of the FC 1 closer to the current usage range. Thus, regulating the resistance value of the resistance device 8 according to the current value of the FC 1 can control the power to be supplied to the motor 2 so as not to exceed the upper limit power of the FC 1 and the battery 4. Further, it is possible to suppress application of high voltage to the FC 1.

### Fourth Embodiment

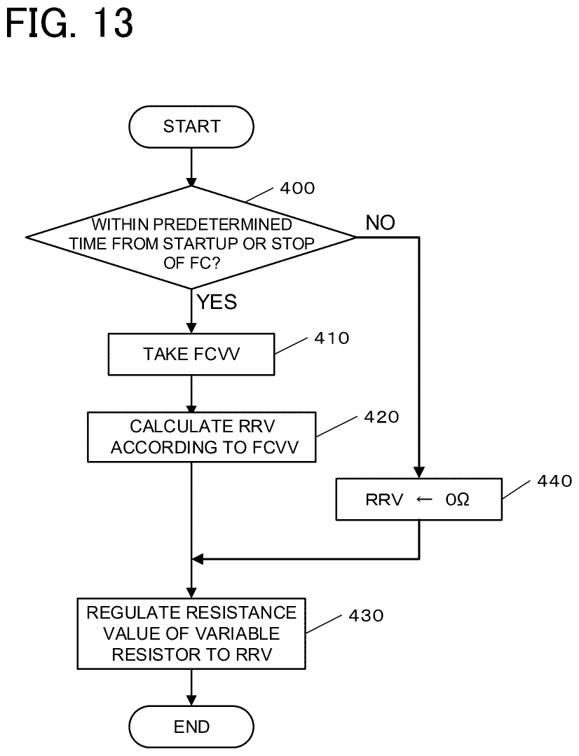

Next, a fourth embodiment will be described in detail referring to FIG. 13 to FIG. 17.

### [Electric Power Supply Control]

This embodiment differs from each of the above-described embodiments in contents of the electric power supply control. FIG. 13 is a flowchart showing the contents of the “electric power supply control” in the present embodiment.

When the process enters this routine, in step 400, the ECU 10 determines whether or not an elapsed time since the FC 1 started or stopped falls within a predetermined time period. Herein, the predetermined time can be set to “3 seconds”, for example. When this determination result is positive, the ECU 10 advances the process to step 410. When this determination result is negative, the ECU 10 shifts the process to step 440.

In step 410, the ECU 10 takes a FC voltage value FCVV under measurement.

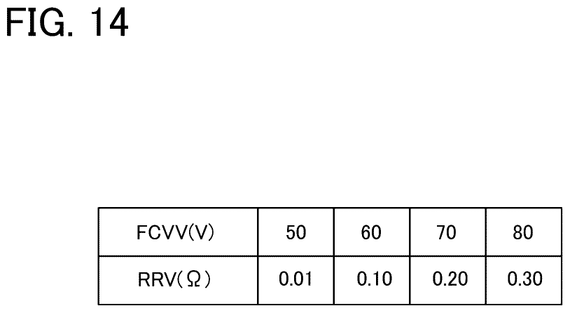

In step 420, the ECU 10 then calculates a required resistance value RRV according to the FC voltage value FCVV. The ECU 10 determines the required resistance value RRV according to the FC voltage value FCVV by, for example, referring to the required resistance value map shown in FIG. 14. This required resistance value map sets a required resistance value RRV for bringing the charge rate SOC of the battery 4 closer to the median value (50%). Specifically, as the FC voltage value FCVV is higher within the range of “50 to 80 (V)”, the required resistance value RRV is set to be higher within the range of “0.01 to 0.30 (Ω)” so that the voltage of the battery 4 is the maximum voltage value or less.

In step 430, subsequently, the ECU 10 regulates the resistance value of the variable resistor 7 to the required resistance value RRV, and terminates subsequent processes.

In contrast, in step 440 following step 400, the ECU 10 sets the required resistance value RRV to “0Ω”, and shifts the process to step 430.

According to the foregoing electric power supply control, the ECU 10 is configured to control the variable resistor 7 to reduce the resistance value of the variable resistor 7 according to the FC voltage value FCVV measured for the predetermined time during startup or stop of the FC 1, so that the voltage of the battery 4 is the maximum voltage value or less or the FC 1 avoids being subjected to high voltage.

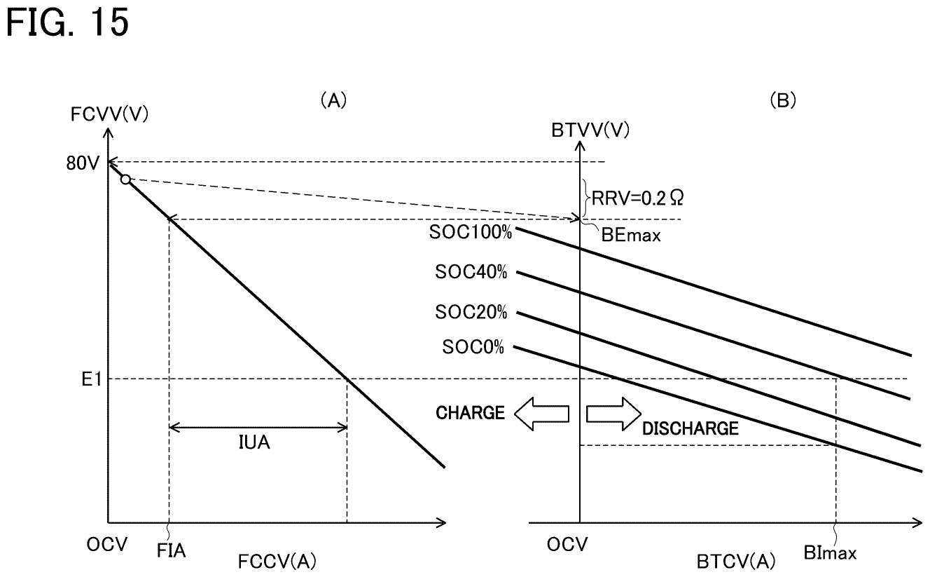

FIG. 15 is a graph, similar to FIG. 11, showing (A) current-voltage characteristics of the FC 1 and (B) current-voltage characteristics of the battery 4. In the present embodiment, during startup or stop of the FC 1, the ECU 10 sets the required resistance value RRV according to the FC voltage value FCVV within the predetermined time during startup or stop so that the voltage of the battery 4 does not exceed a maximum voltage value BEmax.

### [Operations and Effects of Fuel Cell System]

According to the fuel cell system configured as above in the present embodiment, the operations and effects equivalent to those in the first embodiment can be achieved. According to the present embodiment, furthermore, the ECU 10 controls the variable resistor 7 according to the measured FC voltage value FCVV during startup or stop of the FC 1, thereby enabling to suppress the voltage of the battery 4 from exceeding its upper limit value. Thus, regulating the resistance value of the variable resistor 7 according to the FC voltage value FCVV can control the power to be supplied to the motor 2 so as not to exceed the upper limit power of the FC 1 and the battery 4. Further, it is possible to suppress application of high voltage to the FC 1.

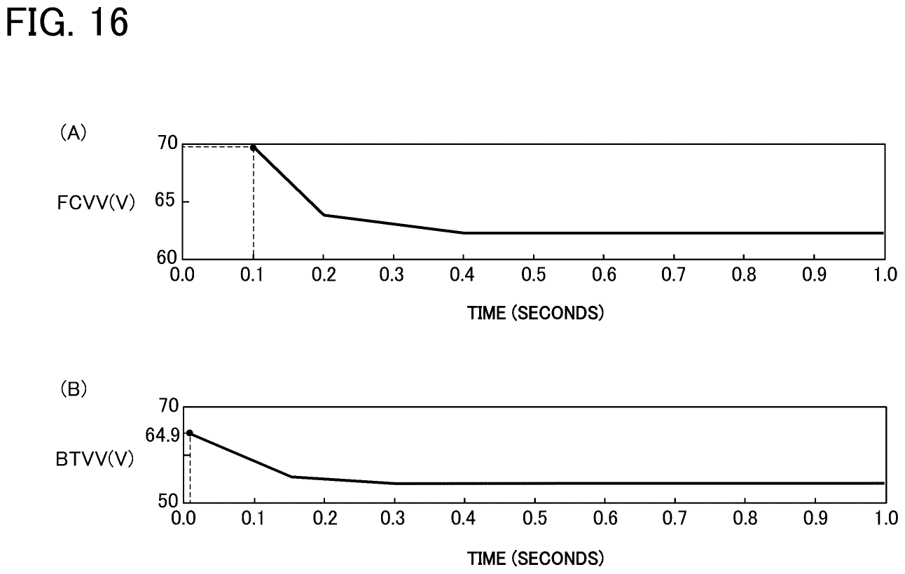

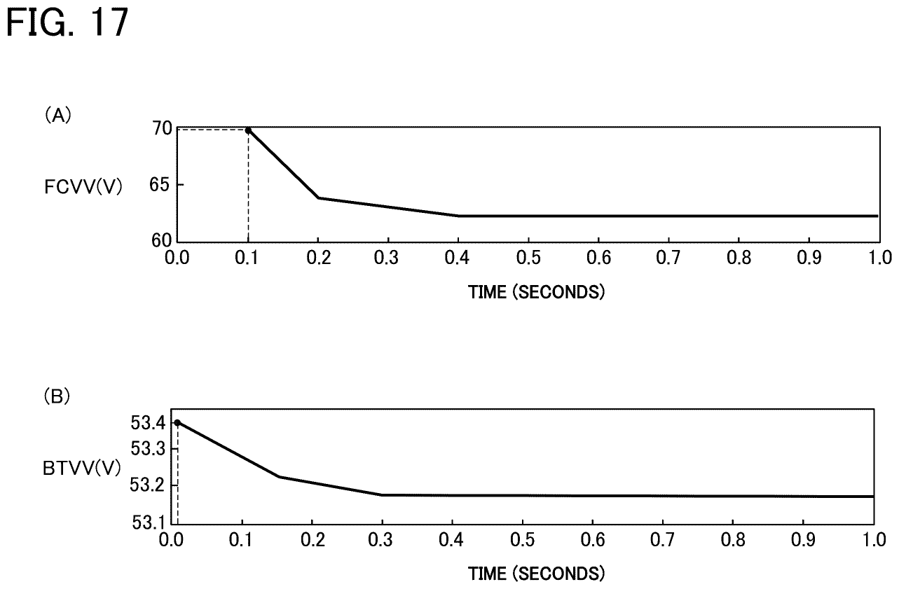

FIG. 16 is a time chart showing changes in (A) the FC voltage value FCVV and (B) the battery voltage value BTVV when the variable resistor 7 is “0Ω” during startup of the FC 1. FIG. 17 is a time chart showing changes in (A) the FC voltage value FCVV and (B) the battery voltage value BTVV when the variable resistor 7 is “1.0Ω” during startup of the FC 1. As shown in FIG. 16 and FIG. 17, when the resistance value of the variable resistor 7 is changed from “0Ω” to “1.0Ω” during startup of the FC 1, the battery voltage value BTVV can be reduced from “64.9 (V)” to “53.4 (V)” that is lower than the upper limit value (e.g., “55 (V)”).

### Modified Example of Fourth Embodiment

Next, a modified example of the fourth embodiment will be described. This modified example differs from the fourth embodiment mainly in configuration of the variable resistance means. In this modified example, on the first power line 3 shown in FIG. 1, a resistance device 8 including four resistor-relay circuits 23 shown in FIG. 9 connected in series is placed instead of the variable resistor 7. This resistance device 8 is configured so that its resistance value can be changed in four stages by selectively opening and closing four relays 22. In other words, the resistance device 8 is configured to change the resistance value to “0.3Ω” by opening all of the relays 22 of the four resistor-relay circuits 23, change the resistance value to “0.20Ω” by opening three of the relays 22 of the four resistor-relay circuits 23, change the resistance value to “0.10Ω” by opening two of the relays 22 of the four resistor-relay circuits 23, change the resistance value to “0.01Ω” by opening one of the relays 22 of the four resistor-relay circuits 23, and change the resistance value to “0Ω” by closing all of the relays 22 of the four resistor-relay circuits 23.

In the “electric power supply control” in the present modified example, the resistance value of the resistance device 8 is regulated to the required resistance value RRV by selectively opening and closing the four relays 22, instead of step 430 shown in FIG. 13.

### [Operations and Effects of Fuel Cell System]

According to the fuel cell system configured as above in the present embodiment, it is possible to achieve the operations and effects equivalent to those in the fourth embodiment. Specifically, the ECU 10 controls the resistance device 8 according to the measured FC voltage value FCVV during startup or stop of the FC 1, thereby enabling to suppress the voltage of the battery 4 from exceeding its upper limit value. Thus, regulating the resistance value of the resistance device 8 according to the FC voltage value FCVV can control the power to be supplied to the motor 2 so as not to exceed the upper limit power of the FC 1 and the battery 4. Further, it is possible to suppress application of high voltage to the FC 1.

### Fifth Embodiment

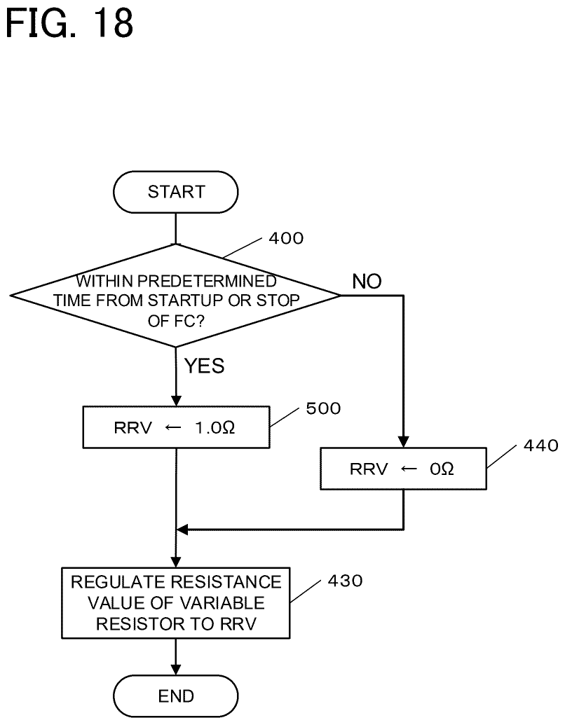

Next, a fifth embodiment will be described in detail referring to FIG. 18.

### [Electric Power Supply Control]

This embodiment differs from the fourth embodiment in contents of the electric power supply control. FIG. 18 is a flowchart showing the contents of the “electric power supply control” in the present embodiment. The flowchart in FIG. 18 differs from the flowchart in FIG. 13 in that step 410 is omitted and step 420 is replaced with the process in step 500. In other words, in step 500, the ECU 10 sets the required resistance value RRV to “1.0Ω”.

According to the forgoing electric power supply control, the ECU 10 is configured to control the variable resistor 7 to increase the resistance value of the variable resistor 7 to “1.0Ω” so that the voltage of the battery 4 does not exceed the upper limit value within the predetermined time during startup or stop of the FC 1.

### [Operations and Effects of Fuel Cell System]

According to the fuel cell system configured as above in the present embodiment, it is possible to achieve the operations and effects equivalent to those in the fourth embodiment.

### Modified Example of Fourth Embodiment

Next, a modified example of the fifth embodiment will be described. This modified example differs from the fifth embodiment mainly in configuration of the variable resistance means. In this modified example, as with the modified example of the second embodiment, the resistance device 8 shown in FIG. 9 is provided on the first power line 3.

In the “electric power supply control” in the present modified example, the resistance value of the resistance device 8 is regulated to the required resistance value RRV by opening and closing the one relay 22, instead of step 430 shown in FIG. 18.

### [Operations and Effects of Fuel Cell System]

According to the fuel cell system configured as above in the present embodiment, it is possible to achieve the operations and effects equivalent to those in the fifth embodiment.

The disclosure is not limited to each of the aforementioned embodiments, and may be implemented with appropriate changes to some of the configurations without departing from the essential characteristics of the disclosure.
(1) In each of the embodiments and each of the modified examples, the variable resistor 7 or the resistance device 8 is provided on the first power line 3 (the FC 1 side), but the variable resistor or the resistance device may be provided on the second power line (the battery side).
(2) In each of the embodiments and each of the modified examples, the electrically-operated motor 2 is adopted as the load device, but other electric motors may also be adopted.
(3) In each of the embodiments and each of the modified examples, a single circuit including the FC 1, the diode 6, and the variable resistor 7 (or the resistance device 8), which are connected in series, is connected to the motor 2. As an alternative, multiple circuits, each including an FC, a diode, and a variable resistor (or a resistance device), which are connected in series, may also be connected to a motor in parallel.
(4) In the modified example of the second embodiment, on the first power line 3, the resistance device 8 is provided, including one resistor-relay circuit 23 that includes one resistor 21 and one relay 22 connected in parallel to the resistor 21. The resistance device 8 is configured so that its resistance value can be changed in two stages by opening and closing the one relay 22. As alternatives, another resistance device may be placed on the first power line and configured to include multiple resistor-relay circuits connected in series, each of the circuits including one resistor and one relay connected in parallel to the resistor, so that its resistance value can be changed in multiple stage by selectively opening and closing a plurality of relays. In this case, when the monitored charge rate is a predetermined first charge rate or less, the ECU controls at least one of the relays to open to regulate the resistance value to the predetermined first resistance value. When the charge rate under monitoring is a predetermined second charge rate or higher, which is higher than the first charge rate, the ECU controls at least one more relay than when the charge rate is the first charge rate or less to open to regulate the resistance value to a predetermined second resistance value that is higher than the first resistance value.

### INDUSTRIAL APPLICABILITY

The disclosure can be utilized to fuel cell systems mounted in electric vehicles.

### REFERENCE SIGNS LIST

1 FC (Fuel cell)
2 Motor (Load device)
3 First power line
4 Battery
5 Second power line
7 Variable resistor (Variable resistance means)
8 Resistance device (Variable resistance means)
10 ECU (Control means, Monitoring means, Measuring means)
21 Resistor
22 Relay
23 Resistor-relay circuit

1. A fuel cell system comprising:
a fuel cell;
a load device;
a first power line connecting the fuel cell and the load device;
a battery; and
a second power line connecting the battery and the first power line,
wherein the fuel cell system further comprises:
variable resistance means provided on the first power line or the second power line and configured so that a resistance value can be changed; and
control means for regulating the resistance value of the variable resistance means so that a current value of the fuel cell falls in a current usage range which is allowable.

2. The fuel cell system according to claim 1, wherein the variable resistance means is a variable resistor configured so that a resistance value can be changed.

3. The fuel cell system according to claim 1, wherein the variable resistance means is a resistance device including at least one resistor-relay circuit provided with one resistor and one relay connected in parallel to the resistor, the resistance device being configured so that a resistance value can be changed in multiple stages by opening and closing the one relay of the at least one resistor-relay circuit.

4. The fuel cell system according to claim 2, further comprising monitoring means for monitoring a charge rate of the battery,
wherein when the charge rate under monitoring is a predetermined first charge rate or less, the control means controls the variable resistance means to regulate the resistance value to a predetermined first resistance value, and
when the charge rate under monitoring is a predetermined second charge rate or more, the control means controls the variable resistance means to regulate the resistance value to a predetermined second resistance value that is higher than the first resistance value.

5. The fuel cell system according to claim 3, further comprising monitoring means for monitoring a charge rate of the battery,
wherein when the charge rate under monitoring is a predetermined first charge rate or less, the control means controls the one relay of the at least one resistor-relay circuit to open to regulate the resistance value to a predetermined first resistance value, and
when the charge rate under monitoring is a predetermined second charge rate or more, the control means controls at least one more relay (22) than when the charge rate is the first charge rate or less to open to regulate the resistance value to a predetermined second resistance value that is higher than the first resistance value.

6. The fuel cell system according to claim 2, further comprising measuring means for measuring a current value of the fuel cell,
wherein when the current value under measuring is a high-current side value in the current usage range of the fuel cell, the control means controls the variable resistor to reduce the resistance value of the variable resistor so that a voltage value of the battery is above a lower limit of a voltage usage range which is allowable, and
when the current value under measuring is a low-current side value in the current usage range of the fuel cell, the control means controls the variable resistor to increase the resistance value of the variable resistor so that the voltage value of the battery is below an upper limit of the voltage usage range or the fuel cell avoids being subjected to high voltage.

7. The fuel cell system according to claim 3, further comprising measuring means for measuring a current value of the fuel cell,
wherein when the current value under measuring is a high-current side value in the current usage range of the fuel cell, the control means controls at least one of the relay to close to reduce the resistance value of the resistance device, and
when the current value under measuring is a low-current side value in the current usage range of the fuel cell, the control means controls the one relay of the at least one resistor-relay circuit to open to increase the resistance value of the resistance device.

8. The fuel cell system according to claim 2, further comprising measuring means for measuring a voltage value of the fuel cell,
wherein, based on the voltage value measured for a predetermined time during startup or stop of the fuel cell, the control means regulates a resistance value of the variable resistor so that the voltage value of the battery is a maximum voltage value or less or the fuel cell avoids being subjected to high voltage.

9. The fuel cell system according to claim 3, further comprising measuring means for measuring a voltage value of the fuel cell,
wherein, when the voltage value measured for a predetermined time during startup or stop of the fuel cell exceeds a maximum voltage value of the battery or when the fuel cell avoids being subjected to high voltage, the control means controls the one relay of the at least one resistor-relay circuit to increase the resistance value.
